(19) United States
(12) Patent Application Publication
(10) Pub. No.: US 2018/0182019 A1
(43) Pub. Date: Jun. 28, 2018

(54) ORDER RECOMMENDATION METHOD AND DEVICE

(71) Applicant: Beijing Xiaodu Information Technology Co., Ltd., Beijing (CN)

(72) Inventor: Fan Jiang, Beijing (CN)

(21) Appl. No.: 15/901,787

(22) Filed: Feb. 21, 2018

Related U.S. Application Data
(63) Continuation of application No. PCT/CN2017/079075, filed on Mar. 31, 2017.

(30) Foreign Application Priority Data
Mar. 31, 2016 (CN) 201610201742.X

(51) Int. Cl. G06Q 30/06; G06Q 10/08; G06Q 30/02

(52) U.S. Cl. CPC G06Q 30/0631; G06Q 30/0222; G06Q 10/083; G06Q 30/0635

(57) ABSTRACT

The present invention provides an order recommendation method and apparatus. The order recommendation method includes: obtaining information about a first logged-in user, and obtaining candidate orders from confirmed orders according to information about the first logged-in user; sorting the candidate orders according to delivery costs that can be saved, and selecting, as selected candidate orders of the first logged-in user, a preset number of candidate orders from the sorted candidate orders in descending sequence based on the delivery costs that can be saved; and determining a second logged-in user wherein a distance between the second logged-in user and the first logged-in user falls within a preset distance, and a login time difference between the second logged-in user and the first logged-in user falls within a preset time; combining and de-duplicating the selected candidate orders for the first logged-in user and the second logged-in user; centrally allocating combined and de-duplicated selected candidate orders to the first logged-in user and the second logged-in user as recommended orders; and presenting the recommended orders to the first logged-in user so that the first logged-in user can place an order according to the recommended orders.

### CROSS REFERENCE

This application is a continuation of International Patent Application No. PCT/CN2017/079075, filed on Mar. 31, 2016 and entitled “ORDER RECOMMENDATION METHOD AND APPARATUS”, which claims priority to Chinese Patent Application No. 201610201742.X, filed with the Chinese Patent Office on Mar. 31, 2016 and entitled “ORDER RECOMMENDATION METHOD AND APPARATUS”, all of which are incorporated herein by reference in their entirety.

### TECHNICAL FIELD

The present invention relates to the field of Internet technologies, and in particular, to an order recommendation method and apparatus.

### BACKGROUND

With the development of Online to Offline (020) technologies, more and more users are purchasing commodities online. After a user purchases a commodity online and an order is generated, offline delivery needs to be performed. To save resources, the order delivery algorithm needs to be well-designed.

In the related art, the order delivery algorithm is generally designed to derive optimal deliveries based on a set of confirmed orders and the real-time status of the delivery person according to a specific algorithm. In principle, orders with similar delivery times, similar order pickup locations, and similar order delivery locations should be combined for delivery to improve delivery efficiency.

However, because delivery times, order pickup locations, and order delivery locations are subject to the order placement of the users, the prior art system can only passively respond to confirmed orders, and optimization is often limited.

### SUMMARY

The present invention aims to solve at least one of technical problems in the related art.

Thus, an objective of the present invention is to provide an order recommendation method. This method can actively affect order placement of the user, and avoid the problem of passive response to the order placement of the user, so as to effectively optimize order delivery. More specifically, orders suitable for recommendation to a particular user are combined with orders suitable for recommendation to other users, and the combined orders are centrally allocated to all users so as to optimize overall savings in delivery costs.

Another objective of the present invention is to provide an order recommendation apparatus.

To achieve the foregoing objectives, an order recommendation method is provided in accordance with a first embody of the present invention: The order recommendation method includes: obtaining information about a first logged-in user, and obtaining candidate orders from confirmed orders according to information about the first logged-in user; sorting the candidate orders according to delivery costs that can be saved, and selecting, as selected candidate orders of the first logged-in user, a preset number of candidate orders from the sorted candidate orders in descending sequence based on the delivery costs that can be saved; and determining a second logged-in user wherein a distance between the second logged-in user and the first logged-in user falls within a preset distance, and a login time difference between the second logged-in user and the first logged-in user falls within a preset time; combining and de-duplicating the selected candidate orders for the first logged-in user and the second logged-in user; centrally allocating combined and de-duplicated selected candidate orders to the first logged-in user and the second logged-in user as recommended orders; and presenting the recommended orders to the first logged-in user so that the first logged-in user can place an order according to the recommended orders.

According to the order recommendation method in the first embodiment of the present invention, the recommended orders are determined from the confirmed orders, and the recommended orders are presented to the user, so that the user can place the order according to the recommended orders. This can actively affect the order placement of the user, and avoid the problem of passive response to the order placement of the user, so as to effectively optimize order delivery. More specifically, orders suitable for recommendation to a particular user are combined with orders suitable for recommendation to other users, and the combined orders are centrally allocated to all users so as to optimize overall savings in delivery costs.

To achieve the foregoing objectives, an order recommendation apparatus is provided in a second embodiment of the present invention: an obtaining module, configured for: obtaining information about a first logged-in user, and obtaining candidate orders from confirmed orders according to information about the first logged-in user; a first unit, configured for: sorting the candidate orders according to delivery costs that can be saved, and selecting, as selected candidate orders of the first logged-in user, a preset number of candidate orders from the sorted candidate orders in descending sequence based on the delivery costs that can be saved; a second unit, configured for: determining a second logged-in user wherein a distance between the second logged-in user and the first logged-in user falls within a preset distance, and a login time difference between the second logged-in user and the first logged-in user falls within a preset time; combining and de-duplicating the selected candidate orders for the first logged-in user and the second logged-in user; and centrally allocating combined and de-duplicated selected candidate orders to the first logged-in user and the second logged-in user as recommended orders; and a presentation module, configured for: presenting the recommended orders to the first logged-in user so that the first logged-in user can place an order according to the recommended orders.

According to the order recommendation apparatus in the second embodiment of the present invention, the recommended orders are determined from the confirmed orders, and the recommended orders are presented to the user, so that the user can place the order according to the recommended orders. This can actively affect the order placement of the user, and avoid the problem of passive response to the order placement of the user, so as to effectively optimize order delivery. More specifically, orders suitable for recommendation to a particular user are combined with orders suitable for recommendation to other users, and the combined orders are centrally allocated to all users so as to optimize overall savings in delivery costs.

Some aspects and advantages of the present invention are set forth in the following descriptions, while some other aspects and advantages of present invention are apparent from the following descriptions or can be learned from the practice of the present invention.

### BRIEF DESCRIPTION OF DRAWINGS

The foregoing and/or additional aspects and advantages of the present invention will be readily apparent from the following description of the embodiments, taken in conjunction with the accompanying drawings.

FIG. 1 is a schematic flowchart of an order recommendation method according to an embodiment of the present invention;

FIG. 2 is a schematic flowchart of an order recommendation method according to another embodiment of the present invention;

FIG. 3 is a schematic flowchart of sorting candidate orders according to delivery costs that can be saved according to an embodiment of the present invention;

FIG. 4 is a schematic flowchart of an order recommendation method according to another embodiment of the present invention;

FIG. 5 is a schematic structural diagram of an order recommendation apparatus according to an embodiment of the present invention; and

FIG. 6 is a schematic structural diagram of an order recommendation apparatus according to another embodiment of the present invention.

### DESCRIPTION OF EMBODIMENTS

The following describes the embodiments of the present invention in detail, and examples of the embodiments are illustrated in the accompanying drawings. Throughout same or similar reference numerals represent same or similar modules or modules having same or similar functions. The embodiments described in the following with reference to the accompanying drawings are examples, and are merely used to explain the present invention, but should be construed as a limitation to the present invention. To the contrary, the embodiments of the present invention include all variations, modifications, and equivalents that fall within the spirit and scope of the appended claims.

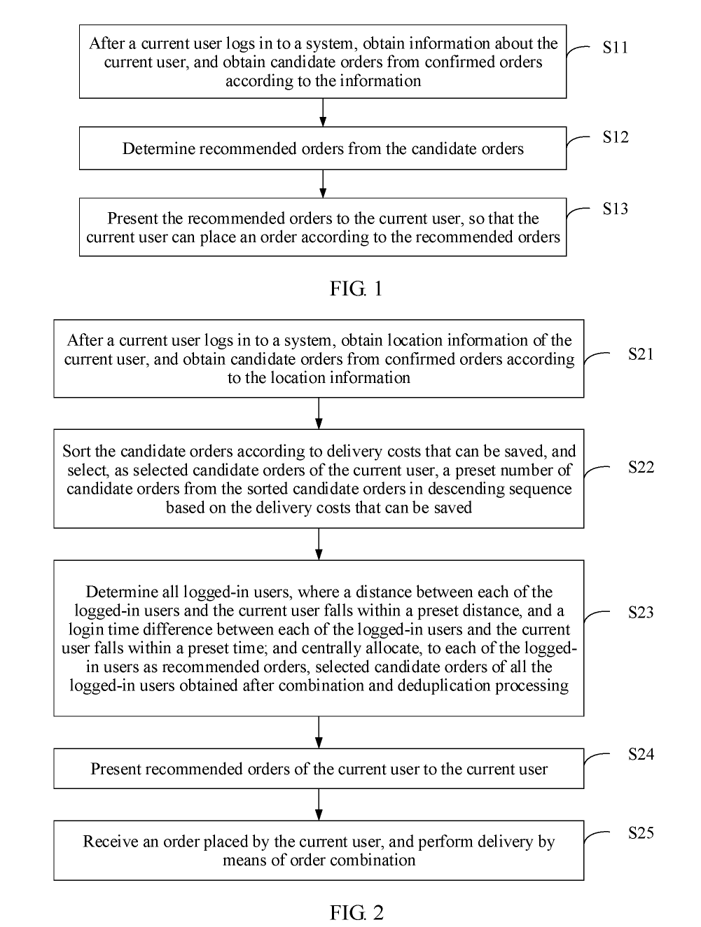

FIG. 1 is a schematic flowchart of an order recommendation method according to an embodiment of the present invention.

Referring to FIG. 1, the method includes the following steps.

S11. After a current user logs in to a system, obtain information about the current user, and obtain candidate orders from confirmed orders according to the information about the current user.

In this embodiment, after a user logs in to a system and before the user places an order, orders may be recommended to the user to guide the user to place an order.

In obtaining candidate orders, confirmed orders within a specific range and a specific time may be selected as candidate orders. The specific range means that the distance between the delivery address and the address of the current user falls within a preset range. The specific time means that the time difference between the confirmation time and the current time falls within a preset range.

S12. Determine recommended orders from the candidate orders.

In this embodiment, a preset number of selected candidate orders may be selected from the candidate orders from the perspective of reducing delivery costs. Then, the recommended orders are determined from these selected candidate orders.

In determining the recommended orders, selected candidate orders of all currently-logged-in users (for example, M users) that meet a specific condition may be combined to obtain combined candidate orders (for example, N candidate orders). Then, the N orders are allocated to the M users, and the orders allocated to each user are the recommended orders of that user. In this process, the orders recommended to the user may include not only a selected candidate order of this user, but also a selected candidate order of another user. In other words, the user can share the selected candidate orders of another user. Therefore, more orders may be more effectively recommended to the user.

In actual implementation, a preset number of selected candidate orders may be selected from the candidate orders based on the degree of interest of the user in the commodities in a candidate order. Then, the recommended orders may be determined from these selected candidate orders, or these selected candidate orders may be directly used as the recommended orders.

To implement this function that a preset number of selected candidate orders are selected from the candidate orders based on the degree of interest of the user in the commodities in a candidate order, the following steps may be used: (1) Obtain a first degree of interest of the user in each commodity in each candidate order; (2) Determine a second degree of interest of the user in each candidate order according to the first degrees of interest; (3) Select a preset number of candidate orders as selected candidate orders in descending sequence based on the second degree of interest, or use, as selected candidate orders, candidate orders whose second degrees of interest are greater than a preset threshold.

The first degree of interest may be obtained by calculation according to preset information of the user. The preset information of the user includes but is not limited to at least one of the following information: attribute information of the user, preference information of the user, or historical behavior information of the user. The attribute information includes but is not limited to the age group to which the user belongs, the gender, the occupation, and the like. The preference information includes but is not limited to the commodity category that the user is interested, the brand, and the like. The historical behavior information includes but is not limited to information such as recent commodity browsing or purchasing behavior.

For example, a male user is usually not interested in commodities such as female cosmetics. Therefore, this type of user usually has a relatively low degree of interest in those candidate orders that include commodities that females are interested, and therefore is less likely to “follow” these orders. Thus, these order usually do not need to be recommended to this type of user.

For another example, if a user prefers a brand, the user usually has a relatively high degree of interest in those candidate orders that include this brand of commodities, and therefore is more likely to “follow” the orders. Thus, these orders usually need to be recommended to this user.

For another example, if a user has browsed “mobile phones of a brand A” in the most recent three months, the user usually has a relatively high degree of interest in those candidate orders that include mobile phones of that brand, and therefore is more likely to “follow” the orders. Thus, these orders usually need to be recommended to this user.

For specific ways of determining the recommended orders, please refer to the subsequent description.

S13. Present the recommended orders to the current user, so that the current user can place an order according to the recommended orders.

After the recommended orders are determined, these recommended orders may be directly presented to the current user.

Alternatively, a prompt message may be presented to the current user, and when the current user opens a page according to the prompt message, the recommended order is presented on the page.

The presented recommended order may include the following content: a remaining selection time (counting down from a confirmation time of the order, and a start time of the countdown can be set to, for example, 5 minutes), order delivery content (that may include other commodities from the same delivery), saved costs (delivery costs that a delivery system is willing to waiver if the order is selected by the user).

After the recommended orders are presented to the user, the user may place the order according to the recommended orders. For example, the user may choose to follow an order that includes a commodity in which the user is interested. Further, when placing the order, in addition to directly following an order, the user may further perform an operation such as addition or deletion on commodities in the recommended order.

In this embodiment, the recommended orders are determined from the confirmed orders, and the recommended orders are presented to the user, so that the user can place the order according to the recommended orders. This can actively affect the order placement of the user, and avoid the problem of passive response to the order placement of the user, so as to effectively optimize order delivery.

FIG. 2 is a schematic flowchart of an order recommendation method according to another embodiment of the present invention.

Referring to FIG. 2, the method includes the following steps.

S21. After a current user logs in to a system, obtain location information of the current user, and obtain candidate orders from confirmed orders according to the location information.

The location information includes, for example, latitude and longitude coordinates and an address.

After the location information of the current user is obtained, a confirmed order may be used as a candidate order of the current user, where a distance between a delivery address of the confirmed order and a location of the current user falls within a preset distance (for example, 5 kilometers), and a difference between a confirmation time of the confirmed order and a current time falls within a preset time (for example, 5 minutes).

Each candidate order may include the following content: a to-be-delivered commodity, a merchant address (order pickup address), a user address (delivery address), and a delivery status of the order. The delivery status includes, for example, whether the order is allocated to a delivery person, the location of the delivery person, and whether the order is combined with another order.

S22. Sort the candidate orders according to delivery costs that can be saved, and select, as selected candidate orders of the current user, a preset number of candidate orders from the sorted candidate orders in descending sequence based on the delivery costs that can be saved.

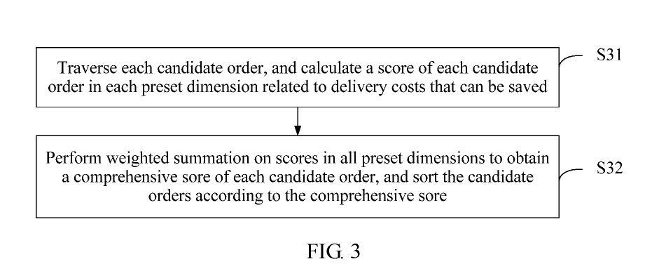

Referring to FIG. 3, sorting the candidate orders according to delivery costs that can be saved includes the following steps:

S31. Traverse each candidate order, and calculate a score of each candidate order in each preset dimension related to the delivery costs that can be saved.

In this embodiment, the preset dimensions related to the delivery costs that can be saved include similarity, timing, and efficiency. The similarity dimension measures the similarity between each candidate order and the current user. The timing dimension measures the timing of each candidate order for the current user. The efficiency dimension measures the improvement in efficiency that each candidate order can provide for the delivery platform.

Scores in the dimensions are calculated in the following manners:

(1) Similarity: similarity is high if the to-be-delivered commodity in a candidate order meets an interest of the current user, and the geographical delivery location of the candidate order is close to the geographical location of the current user. For example, a commodity in which the current user is interested may be determined according to the historical behavior of the current user, such as a purchased or clicked commodity, and the degree to which the to-be-delivered commodity matches the commodity in which the current user is interested is obtained by means of comparison, to determine a corresponding score. In addition, a corresponding score may be determined according to the distance between the two geographical locations. Then, weighted summation is performed on the two scores to obtain a score in similarity. Specifically, the correspondence between a matching degree and a score, the correspondence between a distance and a score, and the weight of each score may be preset, so that the score in similarity may be obtained by calculation.

(2) Timing: timing is high if the confirmation time of a candidate order is close to a current time, the waiting time of the candidate order in a to-be-scheduled sequence is short, and the candidate order is allocated to a delivery person for a short time. Specifically, in a manner similar to the calculation of similarity, a corresponding score may be calculated for each factor (such as the time difference from a current time, or the waiting time), and weighted summation is then performed on scores of all factors to obtain a score in timing. Both the correspondence between each factor and the score, and the weight of each factor may be preset according to experience or the like.

(3) Efficiency: efficiency is high if the delivery distance of a candidate order is long and few orders have been combined. Specifically, in a manner similar to the calculation of the foregoing two dimensions, the corresponding score may be calculated for each factor (such as a delivery distance, the number of combined orders), and weighted summation is then performed on scores of all factors to obtain a score in efficiency. Both the correspondence between each factor and the score, and the weight of each factor may be preset according to experience or the like.

S32. Perform weighted summation on scores in all preset dimensions to obtain a comprehensive score of each candidate order, and sort the candidate orders according to the comprehensive sore.

After scores corresponding to each candidate order in the three dimensions (similarity, timing, and efficiency) are obtained in the foregoing manners, weighted summation may be performed on the scores in the three dimensions to obtain the comprehensive sore. A weight value in each dimension may be preset according to experience or the like.

In the foregoing score calculating process, the higher corresponding scores for similarity, timing and efficiency, the higher the comprehensive score, which indicates higher delivery costs can be saved. Therefore, the candidate orders may be sorted in descending sequence based on the comprehensive sore, and the preset number of candidate orders are selected as the selected candidate orders in front-to-back sequence.

S23. Determine all logged-in users wherein a distance between each of the logged-in users and the current user falls within a preset distance, and a login time difference between each of the logged-in users and the current user falls within a preset time; and centrally allocate, to each of the logged-in users as recommended orders, selected candidate orders of all the logged-in usersobtained after a combination and deduplication processing.

In this embodiment, the selected candidate orders of all the logged-in users who meet the foregoing condition may be combined and centrally allocated.

For example, all the logged-in users who meet the foregoing condition include a first user and a second user. Selected candidate orders of the first user include a first order, a second order, and a third order, and selected candidate orders of the second user include the first order, the second order, and a fourth order. Therefore, orders obtained after combination and deduplication include the first order, the second order, the third order, and the fourth order. Then, the four orders may be centrally allocated to the first user and the second user.

During central allocation, a substantially similar number of candidate orders may be allocated to users, and the candidate orders may have substantially-average delivery costs that may be saved. Specifically, a bipartite-graph maximum matching algorithm such as a KM algorithm may be used so as to optimize overall savings in delivery costs.

After an order is allocated to a user, that allocated order is used as a recommended order of that user. Then, the recommended order of the user may be presented to the user. In a subsequent procedure in this embodiment, one user (the current user) is used as an example, and the same procedure can be used for other users.

S24. Present recommended orders of the current user to the current user.

After the recommended orders are determined, these recommended orders may be directly presented to the current user.

Alternatively, a prompt message may be presented to the current user, and when the current user opens a page according to the prompt message, the recommended order is presented on the page.

The presented recommended order may include the following content: a remaining selection time (counting down from a confirmation time of the order, and a start time of the countdown can be set to, for example, 5 minutes), order delivery content (that may include other commodities from the same delivery), saved delivery costs (delivery costs that a delivery system is willing to waiver if the order is selected by the user).

Furthermore, the prompt message may be presented by a horizontal bar on the top of a home page, which can be clicked to follow an order, and a floating bubble at the bottom of the home page showing number of orders that can be followed.

S25. Receive an order placed by the current user, and deliver the combined orders.

After the recommended orders are presented to the user, the user may select a confirmed order in which the user is interested. Saved costs are reduced from original order costs, and a new order is generated. The user places the order in a limited time.

The delivery platform receives an order following operation in a limited time, re-schedules a delivery task after confirming new order information and original order information, and preferentially combines orders for delivery, so as to improve delivery efficiency.

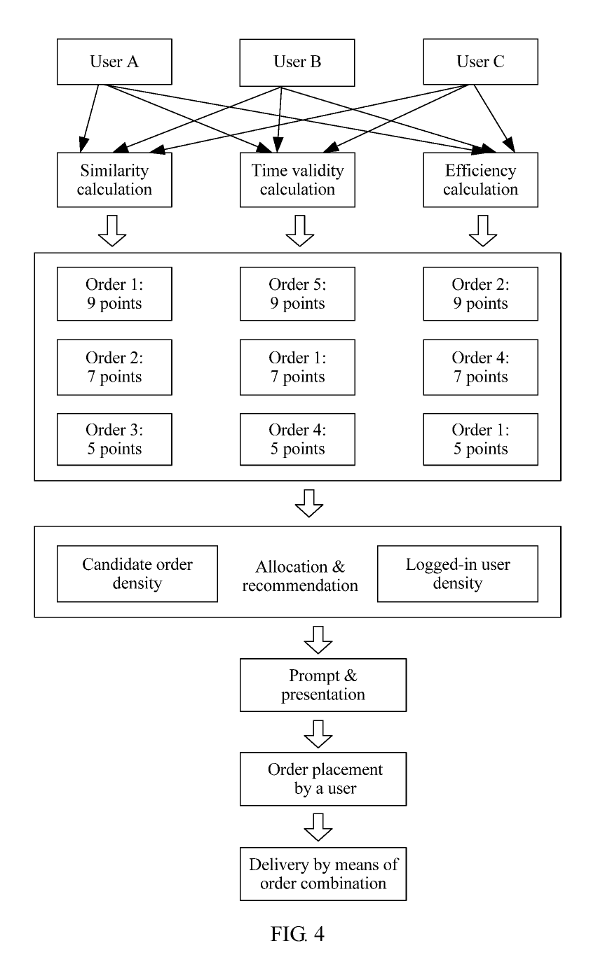

For a specific procedure of applying the foregoing manner, refer to FIG. 4.

A specific example is as follows:

A user A logs in to the system at 11:30 and at a first geographical location. The system selects all confirmed orders within the latest 5 minutes and within a radius of 1 kilometer, and calculates costs that can be saved after the system performs delivery of combined orders if the user A places the same order. Likewise, a user B logs in to the system at 11:31 and at a second geographic location that is 500 m away from the first geographic location, and the system also calculates a set of orders suitable for the user B. These orders may have overlapping components. After allocation and recommendation calculation, these orders are correspondingly allocated to the user A and the user B. The user A and the user B receive respective sets of orders that the user A and the user B can follow, and may choose to place an order according to their respective preferences. The system adds newly generated orders to the delivery task of the confirmed orders, which results deliveries with a higher order combination rate.

In this embodiment, the candidate orders may be determined according to the location and time, the candidate orders may be sorted according to similarity, timing, and efficiency, and a multi-user multi-order globally-optimal delivery solution for reducing delivery costs may be implemented. Therefore, orders with similar delivery times, similar order pickup locations, and similar order delivery locations are obtained and combined into one group of orders for delivery, so as to improve delivery efficiency.

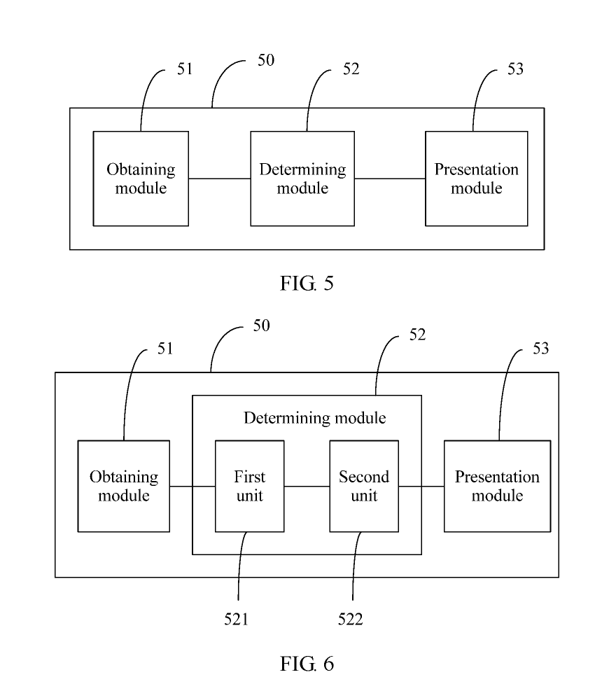

FIG. 5 is a schematic structural diagram of an order recommendation apparatus 50 according to an embodiment of the present invention. Referring to FIG. 5, the apparatus 50 includes an obtaining module 51, a determining module 52, and a presentation module 53.

The obtaining module 51 is configured to: after a current user logs in to a system, obtain information about the current user, and obtain candidate orders from confirmed orders according to information about the current user.

After a user logs in to a system and before the user places an order, in this embodiment, orders may be recommended to the user, to guide the user to place an order.

In obtaining the candidate orders, confirmed orders within a specific range and a specific time may be selected as the candidate orders. The specific range means that the distance between the delivery address and the address of the current user falls within a preset range. The specific time means that the time difference between the confirmation time and the current time falls within a preset range.

The determining module 52 is configured to determine recommended orders from the candidate orders.

In this embodiment, a preset number of selected candidate orders may be selected from the candidate orders from the perspective of reducing delivery costs. Then, the recommended orders are determined from these selected candidate orders.

In determining the recommended orders, selected candidate orders of all currently-logged-in users (for example, M users) that meet a specific condition may be combined, to obtain combined candidate orders (for example, N candidate orders). Then, the N orders are allocated to the M users, and an order allocated to a user is used as a recommended order of that user.

The presentation module 53 is configured to present the recommended orders to the current user, so that the current user can place an order according to the recommended orders.

After the recommended orders are determined, these recommended orders may be directly presented to the current user.

Alternatively, a prompt message may be presented to the current user, and when the current user opens a page according to the prompt message, the recommended order is presented on the page.

The presented recommended order may include the following content: a remaining selection time (counting down from a confirmation time of the order, and a start time of the countdown can be set to, for example, 5 minutes), order delivery content (that may include other commodities from the same delivery), saved delivery costs (delivery costs that a delivery system is willing to waiver if the order is selected by the user).

After the recommended orders are presented to the user, the user may place the order according to the recommended orders. For example, the user may choose to follow an order that includes a commodity in which the user is interested. Further, when placing the order, in addition to directly following an order, the user may further perform an operation such as addition or deletion on commodities in the recommended order.

In some embodiments, the information about the current user includes location of the current user, and that the obtaining module 51 is configured to obtain the candidate orders from the confirmed orders according to the information includes:

using a confirmed order as a candidate order, wherein a distance between the delivery address of the confirmed order and the location of the current user falls within a preset distance, and the time difference between the confirmation time of the confirmed order and the current time falls within a preset time.

After the location of the current user is obtained, a confirmed order may be used as a candidate order of the current user, wherein the distance between the delivery address of the confirmed order and the location of the current user falls within a preset distance (for example, 5 kilometers), and the difference between the confirmation time of the confirmed order and the current time falls within a preset time (for example, 5 minutes).

Each candidate order may include the following content: a to-be-delivered commodity, a merchant address (order pickup address), a user address (delivery address), and a delivery status of the order. The delivery status includes, for example, whether the order is allocated to a delivery person, the location of the delivery person, and whether the order is combined with another order.

In some embodiments, referring to FIG. 6, the determining module 52 includes a first unit 521 and a second unit 522.

The first unit 521 is configured to: sort the candidate orders according to delivery costs that can be saved, and select, as selected candidate orders of the current user, a preset number of candidate orders from the sorted candidate orders in descending sequence based on the delivery costs that can be saved.

Optionally, the first unit 521 is configured to sort the candidate orders according to the delivery costs that can be saved includes:

traversing each candidate order, and calculating a score of each candidate order in each preset dimension related to the delivery costs that can be saved; and

performing weighted summation on scores in all preset dimensions to obtain a comprehensive score of each candidate order, and sorting the candidate orders according to the comprehensive sore.

Optionally, the dimension used by the first unit includes similarity, timing, and efficiency.

In this embodiment, the preset dimension related to the delivery costs that can be saved includes similarity, timing, and efficiency. The similarity dimension measures the similarity between each candidate order and the current user. The timing dimension measures the timing of each candidate order for the current user. The efficiency dimension measures the improvement in efficiency that each candidate order can provide for the delivery platform.

Scores in the dimensions are calculated in the following manners:

(1) Similarity: similarity is high if the to-be-delivered commodity in a candidate order meets an interest of the current user, and the geographical delivery location of the candidate order is close to the geographical location of the current user. For example, a commodity in which the current user is interested may be determined according to the historical behavior of the current user, such as a purchased or clicked commodity, and the degree to which the to-be-delivered commodity matches the commodity in which the current user is interested is obtained by means of comparison, to determine a corresponding score. In addition, a corresponding score may be determined according to the distance between the two geographical locations. Then, weighted summation is performed on the two scores to obtain a score in similarity. Specifically, the correspondence between a matching degree and a score, the correspondence between a distance and a score, and the weight of each score may be preset, so that the score in similarity may be obtained by calculation.

(2) Timing: timing is high if the confirmation time of a candidate order is close to a current time, the waiting time of the candidate order in a to-be-scheduled sequence is short, and the candidate order is allocated to a delivery person for a short time. Specifically, in a manner similar to the calculation of similarity, a corresponding score may be calculated for each factor (such as the time difference from a current time, or the waiting time), and weighted summation is then performed on scores of all factors to obtain a score in timing. Both the correspondence between each factor and the score, and the weight of each factor may be preset according to experience or the like.

(3) Efficiency: efficiency is high if the delivery distance of a candidate order is long and few orders have been combined. Specifically, in a manner similar to the calculation of the foregoing two dimensions, the corresponding score may be calculated for each factor (such as the delivery distance, the number of combined orders), and weighted summation is then performed on scores of all factors to obtain a score in efficiency. Both the correspondence between each factor and the score, and the weight of each factor may be preset according to experience or the like.

After scores corresponding to each candidate order in the three dimensions (similarity, timing, and efficiency) are obtained in the foregoing manners, weighted summation may be performed on the scores in the three dimensions to obtain the comprehensive sore. A weight value in each dimension may be preset according to experience or the like.

In the foregoing score calculating process, the higher corresponding scores for similarity, timing and efficiency, the higher the comprehensive score, which indicates higher delivery costs can be saved. Therefore, the candidate orders may be sorted in descending sequence based on the comprehensive sore, and the preset number of candidate orders are selected as the selected candidate orders in front-to-back sequence.

The second unit 522 is configured to: determine all logged-in users wherein a distance between each of the logged-in users and the current user falls within a preset distance, and a login time difference between each of the logged-in users and the current user falls within a preset time; and centrally allocate, to each of the logged-in users as recommended orders, selected candidate orders of all the logged-in users after a combination and deduplication processing.

In this embodiment, the selected candidate orders of all the logged-in users who meet the foregoing condition may be combined and centrally allocated.

For example, all the logged-in users who meet the foregoing condition include a first user and a second user. Selected candidate orders of the first user include a first order, a second order, and a third order, and selected candidate orders of the second user include the first order, the second order, and a fourth order. Therefore, orders obtained after combination and deduplication include the first order, the second order, the third order, and the fourth order. Then, the four orders may be centrally allocated to the first user and the second user.

During central allocation, a substantially similar number of candidate orders may be allocated to users, and the candidate orders may have substantially-average delivery costs that may be saved. Specifically, a bipartite-graph maximum matching algorithm such as a KM algorithm may be used to optimize overall system performance.

After an order is allocated to a user, that allocated order is used as a recommended order of that user. Then, the recommended order of the user may be presented to the user. In a subsequent procedure in this embodiment, one user (the current user) is used as an example, and the same procedure can be used for other users.

Optionally, the determining module 52 includes: a first-degree-of-interest obtaining sub-unit, configured to obtain a first degree of interest of the current user in each commodity in each candidate order; a second-degree-of-interest obtaining sub-unit, configured to determine a second degree of interest of the current user in each candidate order according to the first degree of interest; a selection sub-unit, configured to: select a preset number of candidate orders as selected candidate orders in descending sequence based on the second degree of interest, or use, as selected candidate orders, candidate orders whose second degrees of interest are greater than a preset threshold; and a determining sub-unit, configured to determine the recommended orders according to the selected candidate orders.

It can be understood that this embodiment is corresponding to the foregoing method embodiment. For specific content, please refer to related description in the method embodiment, and the details are not repeated herein.

In this embodiment, the recommended orders are determined from the confirmed orders, and the recommended orders are presented to the user, so that the user can place the order according to the recommended orders. This can actively affect the order placement of the user, and avoid the problem of passive response to the order placement of the user to effectively optimize order delivery.

It should be noted that in the description of the present invention, the terms “first” and “second” are merely used for description, and cannot be understood as an indication or implication of relative importance. In addition, in the description of the present invention, unless otherwise stated, “multiple” means “at least two”.

Descriptions about any process or method described in a flowchart or in another manner herein may be understood as indicating that one or more modules, segments, or parts of code of an executable instruction to implement a specific logical function or a step of a process are included, the scope of examples of implementations of the present invention includes other implementations, and functions may be performed in a sequence other than a shown or discussed sequence, including in a basically simultaneous manner or a reverse sequence according to the functions concerned. This should be understood by a person skilled in the technological field to which the embodiments of the present invention belong.

It should be understood that various components in the present invention may be implemented by hardware, software, firmware, or a combination thereof. In the foregoing implementations, multiple steps or methods may be implemented by using software or firmware that is stored in a memory and that is executed by an appropriate instruction execution system. For example, if hardware is used for implementation, being similar to implementation in another implementation, any one or a combination of the following well-known technologies in the art may be used for implementation: an independent logic circuit having a logic gate circuit implementing a logical function for a data signal, an application-specific integrated circuit having an appropriate combinatorial logic circuit, a programmable gate array (PGA), a field programmable gate array (FPGA), or the like.

A person of ordinary skill in the art may understand that all or some of the steps of the method embodiments may be implemented by a program instructing relevant hardware. The program may be stored in a computer readable storage medium. When the program runs, one or a combination of the steps of the method embodiments is performed.

In addition, functional units in the embodiments of the present invention may be integrated into one processing module, or each of the units may exist alone physically, or two or more units may be integrated into one module. The integrated module may be implemented in hardware, or may be implemented in a software functional module. When the integrated module is implemented in a software functional module and sold or used as an independent product, the integrated unit may be stored in a computer readable storage medium.

The storage medium may be a read-only memory, a magnetic disk, an optical disk, or the like.

In the description of this specification, descriptions about such reference terms as “an embodiment”, “some embodiments”, “an example”, “a specific example”, and “some examples” mean that specific features, structures, materials, or characteristics described with reference to the embodiments or examples are included in at least one embodiment or example of the present invention. In this specification, the foregoing example expressions of the terms are not necessarily a same embodiment or example. In addition, the described specific features, structures, materials, or characteristics may be combined in a proper manner in any one or more of the embodiments or examples.

Although the embodiments of the present invention are shown and described above, it can be understood that, the foregoing embodiments are examples, and cannot be construed as a limitation to the present invention. Within the scope of the present invention, a person of ordinary skill in the art may make changes, modifications, replacement, and variations to the foregoing embodiments.

What is claimed is:

1. An order recommendation method, comprising:
obtaining information about a first logged-in user, and obtaining candidate orders from confirmed orders according to information about the first logged-in user;
sorting the candidate orders according to delivery costs that can be saved, and selecting, as selected candidate orders of the first logged-in user, a preset number of candidate orders from the sorted candidate orders in descending sequence based on the delivery costs that can be saved; and
determining a second logged-in user wherein a distance between the second logged-in user and the first logged-in user falls within a preset distance, and a login time difference between the second logged-in user and the first logged-in user falls within a preset time;
combining and de-duplicating the selected candidate orders for the first logged-in user and the second logged-in user;
centrally allocating combined and de-duplicated selected candidate orders to the first logged-in user and the second logged-in user as recommended orders; and
presenting the recommended orders to the first logged-in user so that the first logged-in user can place an order according to the recommended orders.

2. The method according to claim 1, wherein obtaining candidate orders from confirmed orders according to the information of the first logged-in user comprises:
selecting a confirmed order as a candidate order when a distance between a delivery address of the confirmed order and a location of the first logged-in user falls within a preset distance, and a time difference between a confirmation time of the confirmed order and a current time falls within a preset time.

3. The method according to claim 1, further comprising:
presenting the recommended orders with delivery costs that can be saved to the first logged-in user.

4. The method according to claim 3, wherein sorting the candidate orders according to delivery costs that can be saved comprises:
calculating a score for each candidate order in each preset dimension related to the delivery costs that can be saved; and
performing weighted summation on scores in the preset dimensions to obtain a comprehensive score for each candidate order, and sorting the candidate orders according to the comprehensive score.

5. The method according to claim 4, wherein the preset dimensions comprise similarity, timing and efficiency.

6. The method according to claim 1, further comprises:
obtaining a first degree of interest of the first logged-in user in each commodity in each candidate order;
determining a second degree of interest of the first logged-in user in each candidate order according to the first degrees of interest;
selecting a preset number of candidate orders as selected candidate orders in descending sequence based on the second degree of interest, or using, as selected candidate orders, candidate orders whose second degrees of interest are greater than a preset threshold; and
determining the recommended orders according to the selected candidate orders.

7. The method according to claim 1, further comprising: centrally allocating combined and de-duplicated selected candidate orders to the first logged-in user and the second logged-in user as recommended orders using a bipartite-graph maximum matching algorithm.

8. The method according to claim 7, wherein the bipartite-graph maximum matching algorithm comprises a KM algorithm.

9. An order recommendation apparatus, comprising:
an obtaining module, configured for: obtaining information about a first logged-in user, and obtaining candidate orders from confirmed orders according to information about the first logged-in user;
a first unit, configured for: sorting the candidate orders according to delivery costs that can be saved, and selecting, as selected candidate orders of the first logged-in user, a preset number of candidate orders from the sorted candidate orders in descending sequence based on the delivery costs that can be saved;
a second unit, configured for: determining a second logged-in user wherein a distance between the second logged-in user and the first logged-in user falls within a preset distance, and a login time difference between the second logged-in user and the first logged-in user falls within a preset time; combining and de-duplicating the selected candidate orders for the first logged-in user and the second logged-in user; and centrally allocating combined and de-duplicated selected candidate orders to the first logged-in user and the second logged-in user as recommended orders; and
a presentation module, configured for: presenting the recommended orders comprising delivery costs that can be saved to the first logged-in user so that the first logged-in user can place an order according to the recommended orders.

10. The apparatus according to claim 9, wherein the information about the first logged-in user comprises a location of the first logged-in user, and the obtaining module is configured for selecting a confirmed order as a candidate order when a distance between a delivery address of the confirmed order and a location of the first logged-in user falls within a preset distance, and a time difference between a confirmation time of the confirmed order and a current time falls within a preset time.

11. The apparatus according to claim 9, wherein the bipartite-graph maximum matching algorithm is a KM algorithm, and presentation module is further configured for presenting the recommended orders with delivery costs that can be saved to the first logged-in user.

12. The apparatus according to claim 11, wherein that the first unit is configured to sort the candidate orders according to the delivery costs that can be saved comprises:
calculating a score for each candidate order in each preset dimension related to the delivery costs that can be saved; and
performing weighted summation on scores in all preset dimensions to obtain a comprehensive score of each candidate order, and sorting the candidate orders according to the comprehensive sore.

13. The apparatus according to claim 12, wherein the dimension used by the first unit comprises similarity, timing and efficiency.

14. The apparatus according to claim 9, wherein the determining module comprises:
a first-degree-of-interest obtaining sub-unit, configured to obtain a first degree of interest of the first logged-in user in each commodity in each candidate order;
a second-degree-of-interest obtaining sub-unit, configured to determine a second degree of interest of the first logged-in user in each candidate order according to the first degrees of interest;
a selection sub-unit, configured to: select a preset number of candidate orders as selected candidate orders in descending sequence based on the second degree of interest, or use, as selected candidate orders, candidate orders whose second degrees of interest are greater than a preset threshold; and
a determining sub-unit, configured to determine the recommended orders according to the selected candidate orders.

15. The apparatus according to claim 9, wherein the second unit is further configured for:
centrally allocating combined and de-duplicated selected candidate orders to the first logged-in user and the second logged-in user as recommended orders using a bipartite-graph maximum matching algorithm.

16. The method according to claim 15, wherein the bipartite-graph maximum matching algorithm comprises a KM algorithm.

17. A computer readable storage medium, wherein the computer readable storage medium stores a computer instruction, and the computer instruction is executed by a processor for:
obtaining information about a first logged-in user, and obtaining candidate orders from confirmed orders according to information about the first logged-in user;
sorting the candidate orders according to delivery costs that can be saved, and selecting, as selected candidate orders of the first logged-in user, a preset number of candidate orders from the sorted candidate orders in descending sequence based on the delivery costs that can be saved; and
determining a second logged-in user wherein a distance between the second logged-in user and the first logged-in user falls within a preset distance, and a login time difference between the second logged-in user and the first logged-in user falls within a preset time;
combining and de-duplicating the selected candidate orders for the first logged-in user and the second logged-in user;
centrally allocating combined and de-duplicated selected candidate orders to the first logged-in user and the second logged-in user as recommended orders; and
presenting the recommended orders to the first logged-in user so that the first logged-in user can place an order according to the recommended orders.

18. The computer readable storage medium according to claim 17, wherein the computer instruction is further executed by the processor for:
presenting the recommended orders with delivery costs that can be saved to the first logged-in user.

19. The computer readable storage medium according to claim 17, wherein the computer instruction is further executed by the processor for:
centrally allocating combined and de-duplicated selected candidate orders to the first logged-in user and the second logged-in user as recommended orders using a bipartite-graph maximum matching algorithm.

20. The computer readable storage medium according to claim 19, wherein the bipartite-graph maximum matching algorithm comprises a KM algorithm.
